(19) United States
(12) Patent Application Publication
(10) Pub. No.: US 2008/0281439 A1
(43) Pub. Date: Nov. 13, 2008

(54) Building automation systems and methods

(75) Inventor: Timothy Salsbury, Whitefish Bay, WI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 11/801,243

(22) Filed: May 9, 2007

(51) Int. Cl. G05B 13/02; G05B 11/01; G21C 17/00; G01M 1/38

(52) U.S. Cl. 700/29; 700/71; 702/183; 700/54; 700/278

(57) ABSTRACT

An environment control system which includes a network, a plurality of units and a controller. The system being configured to utilize a nonlinearity compensation controller to compensate for nonlinearity in the system.

### BACKGROUND

The present disclosure relates generally to the field of building automation systems and methods, and more particularly to closed loop static nonlinearity estimation.

Environment control networks or facility management systems are employed in office buildings, manufacturing facilities, and the like, for controlling the internal environment of the facility. The environment control network may be employed to control temperature, fluid flow, humidity, lighting, boilers, chillers, or security in the internal environment.

For example, in environment control networks configured to control temperature and air flow, controlled air units (variable air volume (VAV) boxes or unitary devices (UNT)) are located throughout the facility and provide environmentally controlled air to the internal environment. The controlled air is provided at a particular temperature or humidity so that a comfortable internal environment is established.

The VAV boxes are coupled to an air source which supplies the controlled air to the VAV box via duct work. VAV boxes and unitary devices may include a fan or other device for blowing the controlled air. VAV boxes and unitary devices provide the controlled air through a damper. The damper regulates the amount of the controlled air provided to the internal environment. The damper is coupled to an actuator which positions the damper so that appropriate air flow (measured in cubic feet per minute (CFM)) is provided to the internal environment.

A digital controller is generally associated with at least one actuator and damper. The controller receives information related to the air flow and temperature in the internal environment and appropriately positions the actuator so that the appropriate air flow is provided to the internal environment. The controller may include feedback mechanisms such as proportional integral derivative (PID) control algorithms.

The static characteristic of a plant is a curve that relates the steady-state input and output. The slope of the curve is the plant static gain. When the relation between plant input and output is a straight line, the plant has a constant static gain. Variations in the slope means that the plant has static nonlinearity. Static nonlinearity can be problematic in control loops because most controllers, such as the ubiquitous PID controller, are linear. Coupling linear controllers with statically nonlinear plants means that control performance will vary with the operating point. For example, a loop might start oscillating at one point but be sluggish at another.

Ideally, open-loop experiments should be carried out on the plant to assess static nonlinearity. However, in many industrial applications, systems have slow dynamics and open loop tests are either too time consuming or too disruptive. Static nonlinearity might also develop or change over time making the results of one-time tests invalid. Adaptive controllers can compensate for static nonlinearity, but these controllers are usually designed to be adaptive to changes that are a function of time, rather than operating point. With static nonlinearity, changes in operating point would cause these controllers to constantly retune with the returning lagging the deterioration in control performance. A solution to a static nonlinearity problem is to modify the control law. Standard techniques exist for doing this, such as gain scheduling and functional inversion. However, the problem still remains on how to estimate the nonlinearity of a system and to modify system inputs to minimize the detrimental effects caused by nonlinearity in a system.

What is needed is a system and/or method that satisfies one or more of these needs or provides other advantageous features. Other features and advantages will be made apparent from the present specification. The teachings disclosed extend to those embodiments that fall within the scope of the claims, regardless of whether they accomplish one or more of the aforementioned needs.

### SUMMARY

One embodiment relates to an environmental control system including a network and a plurality of units for controlling a process. The plurality of units for controlling the process including an appliance for controlling a portion of the process and a controller. The controller operatively associated with each of the plurality of units for controlling the process and the controller includes an appliance output in communication with the appliance providing an appliance signal for controlling the appliance, a communication port, a memory, and a processor in communication with the memory, the appliance output, and the communication port. The processor provides the appliance signal to control the appliance. The processor is also programmed to perform a calculation logic and store a calculation logic results in the memory related to the appliance signal. The system also includes a computer in communication with the communication port and the processor provides the stored calculation logic results to the computer via the communication port in response to a summary command for the computer.

Another embodiment relates to a method of generating a performance index for monitoring performance of the controllers, the method including periodically sampling a parameter related to the process for each of the plurality of controllers wherein the parameter is received from a sensor. The method also includes generating a time series model of the parameter. The time series model of the parameter being the performance index. The method further includes storing the time series model of the parameter and transmitting the stored time series model of the parameter to the computer in response to a command from the computer.

Another embodiment relates to an environmental controller operatively associated with an environmental appliance. The environmental controller in communication with a communications bus. The environmental controller for use in a system including a station coupled with the communication bus, the environmental controller including parameter input means for receiving a parameter value from a sensor and a communication port in communication with the communication bus. The system also includes memory means for storing system data including diagnostic information and processor means in communications with the memory means, the parameter input means, and the communication port, for generating diagnostic information and receiving the parameter value. The system further includes the processor means receiving the parameter value at the parameter input. The processor means being programmed to generate the diagnostic information. The diagnostic information being related to a calculation logic and the processor means providing the diagnostic information to the communication port. The communication port providing the diagnostic information to the communication bus and the communication bus providing the diagnostic information to the station.

### BRIEF DESCRIPTION OF THE DRAWINGS

The disclosure will become more fully understood from the following detailed description, taken in conjunction with the accompanying figures.

FIG. 1 is an isometric view of a building, according to an exemplary embodiment with an HVAC system;

FIG. 2 is a schematic block diagram of an environment control system, according to an exemplary embodiment;

FIG. 3 is a schematic block diagram of a controller and a VAV box for use in the environmental control system illustrated in FIG. 2, according to an exemplary embodiment;

FIG. 4 is a more detailed schematic block diagram of the controller illustrated in FIG. 3, according to an exemplary embodiment;

FIG. 5 is a block diagram schematically illustrating control of room temperature by the controller, according to an exemplary embodiment;

FIGS. 6A-6C are illustrations of two non-linear plant characteristic curves and an ideal linear plant characteristic curve, according to exemplary embodiments;

FIG. 7 is an illustration of a closed loop system utilized to control a space conditioning system, according to one embodiment;

FIGS. 8A-8B are illustrations of a conversion of sigma estimates to piecewise linear functional approximation, according to one embodiment;

FIG. 9 is an illustration of an alternative approach for controlling a space conditioning system, according to one embodiment;

FIG. 10 is a flowchart illustrating the calculation logic process flow, according to an exemplary embodiment;

FIG. 11 is an illustration of a method of determining which equipment requires maintenance and/or replacement, according to an exemplary embodiment; and

FIG. 12 is a flowchart illustrating an equipment maintenance reporting procedure.

### DETAILED DESCRIPTION OF THE EXEMPLARY EMBODIMENTS

Before turning to the figures which illustrate the exemplary embodiments in detail, it should be understood that this application is not limited to the details or methodology set forth in the following description or illustrated in the figures. It should also be understood that the phraseology and terminology employed herein is for the purpose of description only and should not be regarded as limiting.

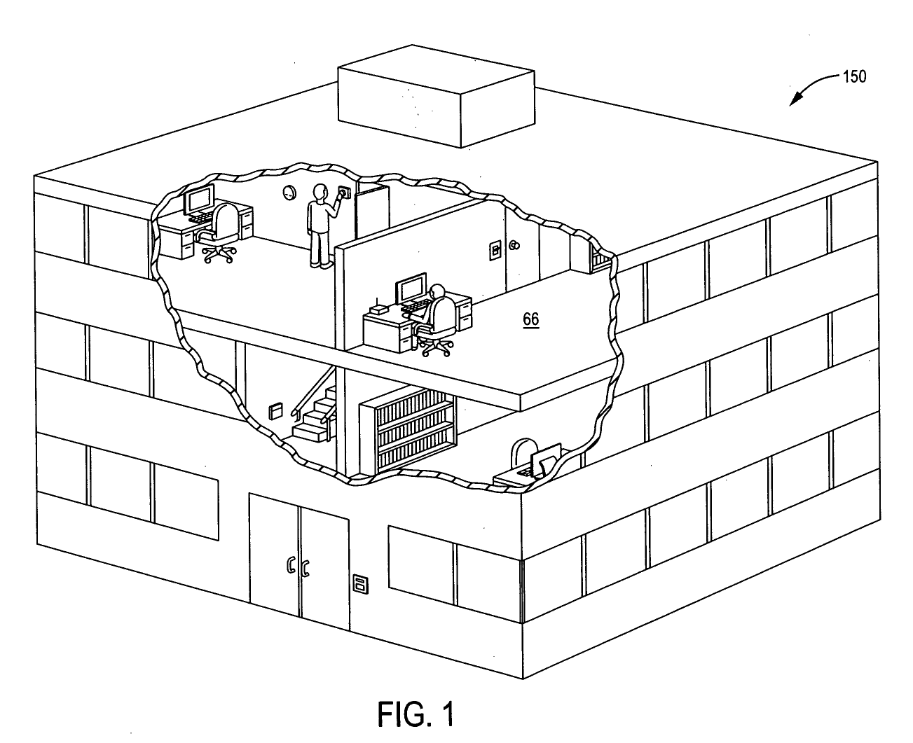

In FIG. 1, a building 150 is shown which may include control elements such as valves, dampers, actuators, or any combination thereof. In an exemplary embodiment, the method of estimating the static nonlinearity considers these control elements. In an exemplary embodiment, the control system may assess the nonlinearity of a system when the system is operating under normal closed loop control. In an exemplary embodiment, the system and method is non-intrusive, because it does not require any change in the operation of the system and may be used to both detect and quantify the amount of nonlinearity. In an exemplary embodiment, the characterization of nonlinearity derived by this disclosure may be used to remedy a system error by introducing additional nonlinear functions into the control loop. In an exemplary embodiment, the air-handling unit is part of a heating, ventilation and air conditioning (HVAC) system which controls an environment 66 of building 150.

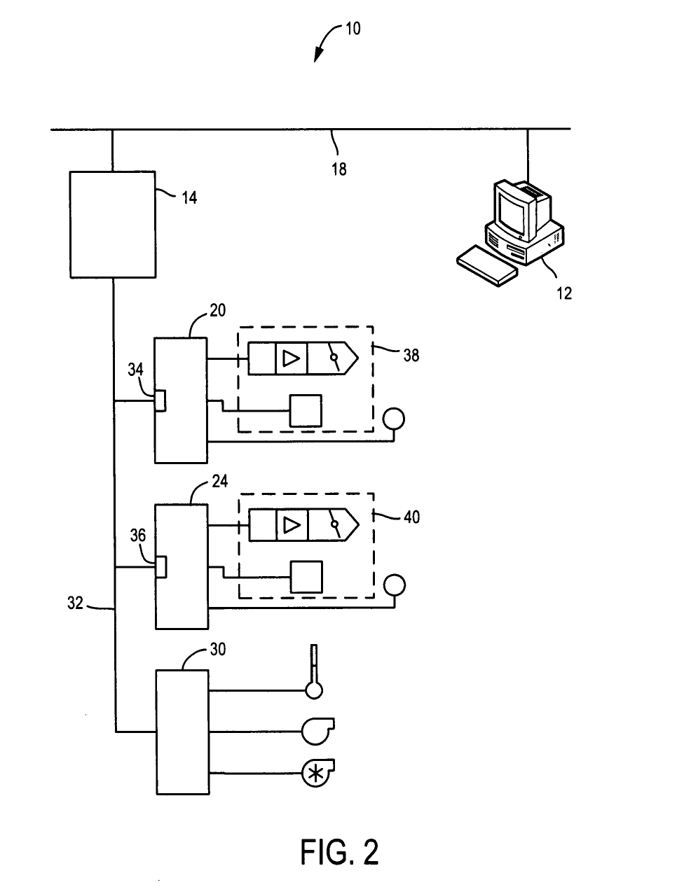

Referring to FIG. 2, an environment control system or network 10 includes a work station 12, a station 14, and a plurality of controllers and/or modules 20, 24, and 30, according to an exemplary embodiment. Controllers 20, 24, and module 30 are coupled with station 14 via a communication link 32. Work station 12 and station 14 are coupled together via a communication bus 18. Communication bus 18 may be coupled to additional sections or additional controllers, as well as other components utilized in environment control network 10.

In an exemplary embodiment, environment control network 10 is a facilities management system such as the METASYS® system manufactured by Johnson Controls, Inc. (JCI) for use with VAV boxes 38 and 40. Alternatively, network 10 can be a unitary system having roof-top units or other damper systems.

In an exemplary embodiment, controller 20 is operatively associated with a controlled air unit such as VAV box 38, and controller 24 is operatively associated with a controlled air unit such as VAV box 40. Controller 20 communicates with work station 12 via communication link 32 through station 14 and communication bus 18. Station 14 multiplexes data over communication link 32 to communication bus 18. Station 14 operates to receive data on communication link 32, provide data to communication bus 18, receive data on communication bus 18, and provide data to communication link 32. Station 14 is capable of other functions useful in environment control network 10. In an exemplary embodiment, work station 12 may be a personal computer, a mobile computing device (i.e., portable computer, personal digital assistant) or any other computing device.

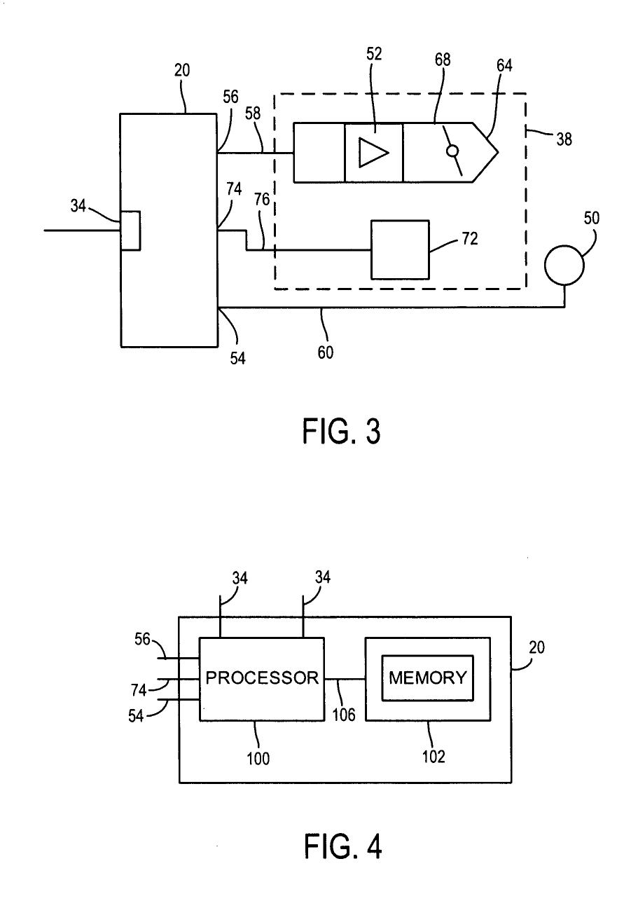

The following is a more detailed description of controller 20 and VAV box 38 with reference to FIG. 3. In an exemplary embodiment, controller 20 is a direct digital control (DDC) which includes a communication port 34 coupled with communication link 32 (FIG. 2). Controller 20 includes an air flow input 56, a temperature input 54, and an actuator output 74. VAV box 38 may additionally include fans, heating or cooling units, exhaust dampers, and return dampers (not shown) for treating an air flow 64. Inputs 54 and 56 are analog inputs received by an A/D converter (not shown) in controller 20. Controller 20 includes circuitry and software for conditioning and interpreting the signals on inputs 54 and 56.

In an exemplary embodiment, VAV control box 38 includes a damper 68, an air flow sensor 52, and an actuator 72. Actuator 72 positions damper 68 and is an electric motor based actuator. Alternatively, actuator 72 and controller 20 may be pneumatic or any other type of device for controlling and positioning damper 68. In an exemplary embodiment, actuator 72 is a motor having a full stroke time (T.sub.stroke) of 1, 2, or 5.5 minutes for a 90 degree stroke.

In an exemplary embodiment, the position of damper 68 controls the amount of air flow 64 provided to environment 66 (See FIG. 1). Environment 66 is a room, hallway, building, a portion thereof, or other internal environment. Air flow sensor 52 provides a parameter such as an air flow parameter across conductor 58 to air flow input 56. The air flow parameter represents the amount of air flow 64 provided through damper 68 to an environment 66.

In an exemplary embodiment, controller 20 provides an actuator output signal to actuator 72 from actuator output 74 via a conductor 76. Controller 20 receives a temperature signal from a temperature sensor 50 across a conductor 60 at temperature input 54. Temperature sensor 50 is generally a resistive sensor located in environment 66.

In an exemplary embodiment, air flow sensor 52 is a differential pressure sensor (.DELTA.P) which provides a DELTA P factor related to air flow (volume/unit time; hereinafter CFM air flow).

With reference to FIGS. 2 and 3, the operation of network 10 is described as follows. In an exemplary embodiment, controllers 20 and 24 are configured to appropriately position actuator 72 in accordance with a cyclically executed control algorithm. In an exemplary embodiment, the control algorithm is an integral (I), a proportional (P), proportional integral (PI), a proportional derivative (PD), a proportional-integral derivative (PID), any feedback logic control algorithm, or any combination thereof. In accordance with the algorithm, at every cycle controller 20 receives the air flow value at input 56, the temperature value at input 54, and other data (if any) from communication link 32 at port 34. Controller 20 provides the actuator output signal at the actuator output 74 every cycle to accurately position damper 68 so that environment 66 is appropriately controlled (heated, cooled, or otherwise conditioned). Thus, controller 20 cyclically responds to the air flow value and the temperature value and cyclically provides the actuator output signal to appropriately control internal environment 66.

In an exemplary embodiment, the system may utilize temperature, humidity, flow rate, pressure, industrial system characteristics or any feedback loop data in the calculation logic.

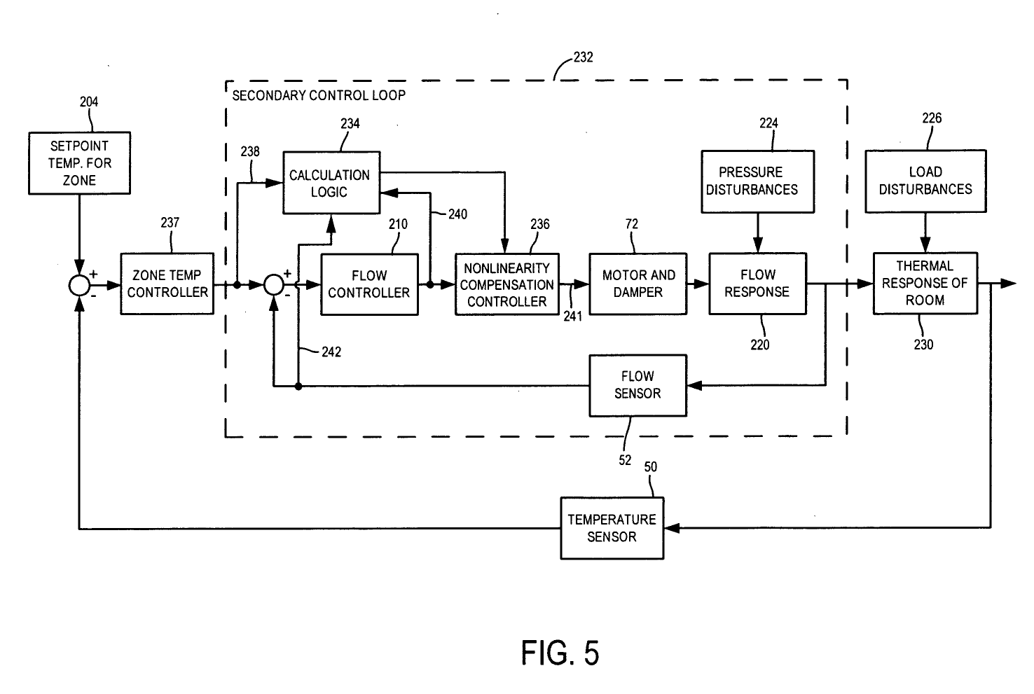

In an exemplary embodiment, the system can be utilized with air handling units. In an exemplary embodiment, these air handling units may have water-to-air heat exchangers for providing heating and cooling to an air stream. The flow of water through the coils is regulated by a hydronic valve, which is moved by an electric actuator connected to a controller. The valve position is adjusted to maintain the air temperature coming off the heat exchangers within a specific range (i.e., setpoint). These valves (combined with the heat exchanger) often have very nonlinear characteristics. This is a single control loop system, which may be illustrated in the cascade system (see FIG. 5) as a secondary control loop 232.

In another exemplary embodiment of a single control loop, variable speed drives are used with on fans in a HVAC system. The variable speed drives allow the air flow rate to vary with the load on the system. In an exemplary embodiment, the fan drive speed may be controlled based on a measured static pressure in the ductwork. The controller is used to regulate the fan speed to maintain static pressure to a specific pressure (i.e., setpoint). This system may also be illustrated in the cascade system (see FIG. 5) as secondary control loop 232.

In another exemplary embodiment of a single control loop, air dampers may be used to mix recirculated air from buildings with the air from the outside. In an exemplary embodiment, three dampers are used which are an outside damper, a recirculation damper, and an exhaust damper. A single signal may be used to move all three dampers together to control the air mixture. The air mixture may be full outside air, full recirculated air or mixture of outside air and recirculated air.

The actuator output signals are pulse width signals which cause actuator 72 to move forward, backward, or stay in the same position, and controller 20 internally keeps track of the position of actuator 72 as it is moved. Alternatively, actuator 72 may provide feedback indicative of its position, or the actuator signal may indicate the particular position to which actuator 72 should be moved.

Referring to FIG. 4, a more detailed block diagram of controller 20 in accordance with an exemplary aspect of the present disclosure is shown. Controller 20 includes a processor 100 coupled with actuator output 74, temperature input 54, air flow input 56, and communication port 34.

Controller 20 also includes a memory 102. Memory 102 includes both a volatile memory and a non-volatile memory. Volatile memory may be configured so that the contents stored therein may be erased during each power cycle of the system. Non-volatile memory may be configured so that the contents stored therein may be retained across power cycles, such that upon system power-up, data from previous system use remains available for the user.

Communication link 32 and communication bus 18 are generally configured to establish communication link with remote source. In one exemplary embodiment, the system may establish a wireless communication link such as with Bluetooth communications protocol, an IEEE 802.11 protocol, an IEEE 802.16 protocol, a cellular signal, a Shared Wireless Access Protocol-Cord Access (SWAP-CA) protocol, a wireless USB protocol, or any other suitable wireless technology. In another exemplary embodiment, communication link 32 and communication bus 18 may establish a wired communication link such as with USB technology, IEEE 1394 technology, optical technology, other serial or parallel port technology, or any other suitable wired link. Communication bus 18 and communication link 32 may receive one or more data files from a remote source. In various exemplary embodiments, the data files may include text, numeric data, audio, video, or any combination thereof.

The operation of controller 20 is described in more detail below with reference to FIGS. 2-5. FIG. 5 is an exemplary block diagram representing the cascade control of a parameter such as room temperature for environment 66. Processor 100 receives the actual temperature of environment 66 from sensor 50 and a temperature set point from a thermostat 204 or other device. A zone temperature control 237 receives inputs from thermostat 204 and sensor 50. In an exemplary embodiment, the temperature control signal is generated by processor 100 in accordance with the PID algorithm so that environment 66 reaches the desired temperature.

At flow controller stage 210, processor 100 receives the actual air flow from flow sensor 52 and the temperature control signal and determines the appropriate air flow to be provided to environment 66 in accordance with the PID algorithm. Flow controller stage 210 operates to move actuator 72 and to move damper 68 (FIG. 2) so that internal environment 66 reaches the appropriate temperature.

Pressure disturbances 224 from internal environment 66 or within VAV box 38 may affect flow response 220 of VAV box 38. Flow response 220 is sampled by flow sensor 52, which provides the actual air flow as discussed above. Similarly, load disturbances 226 may affect thermal response 230 of internal environment 66. Load disturbances 226 may result from door use, people, or other actions or inactions which may affect the temperature within internal environment 66. Thermal response 230 is sampled by temperature sensor 50, which provides the actual temperature as discussed above. Processor 100 compensates for pressure disturbances 224 and load disturbances 226 in stage 210 so that the temperature and air flow in environment 66 is comfortable.

In an exemplary embodiment, flow controller 210 transmits a flow control signal 240 to initiate a ten percent incremental increase in flow. The ten percent incremental increase in flow may have a disproportional affect on the system based on which particular operating region the system is functioning in. In other words, a ten percent incremental increase in flow in region 1 may correspond with an actual effective increase of thirty percent. Whereas, a ten percent incremental increase in flow in region 10 may correspond with an actual effective increase of only two percent.

In an exemplary embodiment, calculation logic 234 receives setpoint signal 238, flow sensor signal 242 and flow control signal 240. In this exemplary embodiment, the system's sub-regions of operation have been predetermined. In this exemplary embodiment, there are ten sub-regions. It should be noted that the sub-regions may be any number from 2 to ∞. As those skilled in the art will recognize, the number of sub-regions will be a design choice.

Calculation logic 234 samples the data provided by setpoint signal 238, flow sensor signal 242 and flow control signal 240 to create sub-region models. Calculation logic 234 transmits these sub-region models to a nonlinearity compensation controller 236. Nonlinearity compensation control 236 compensates for nonlinearity in flow controller 210 by modifying flow control signal 240 and transmitting a modified flow control signal 241 to actuator 72.

In an exemplary embodiment, the control is implemented in the PID algorithm executing within processor 100 of controller 20. In accordance with the PID algorithm, processor 100 also calculates and stores diagnostic or performance indices. The calculation of performance indices by processor 100 in controller 20 is discussed below. In an exemplary embodiment, performance indices may include parameters, such as the absolute value error for temperature, pressure, air flow or humidity. These indices may also include the actual temperature measured by temperature sensor 50 or air flow measured by sensor 52, the change in the actuator position signal, the temperature set point provided by thermostat 204, the duty cycle of actuator 72, or the number of starts, stops and reversals of actuator 72. Controller 20 may be configured to track the number of starts, stops and reversals of actuator 72.

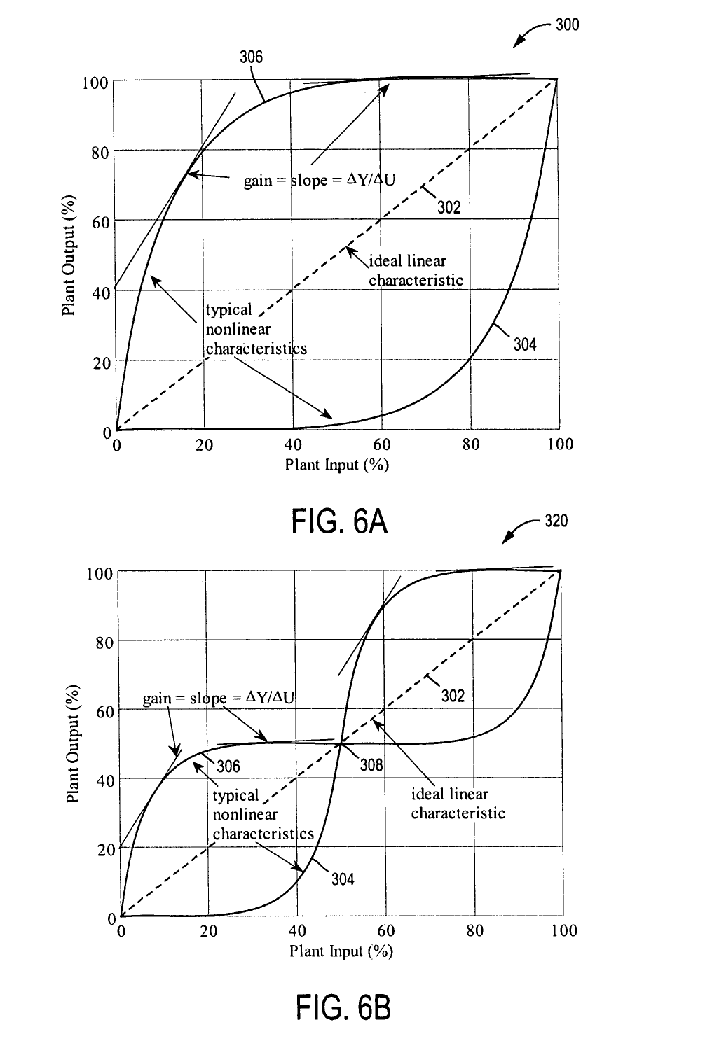

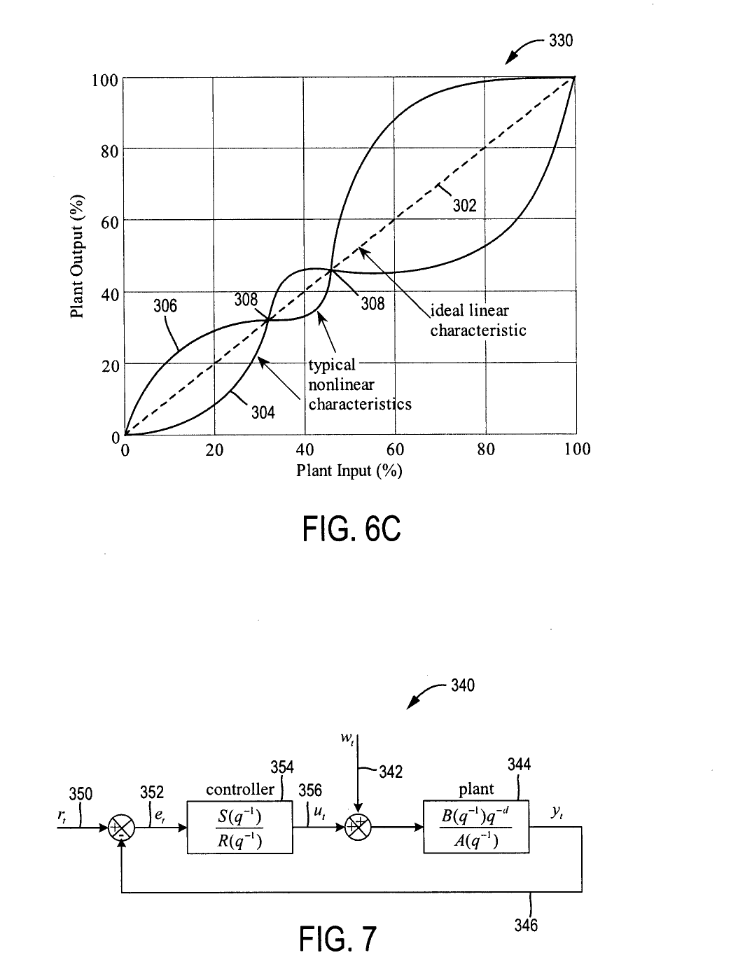

Referring to FIGS. 6A-6C, two nonlinear plant characteristics and an ideal linear plant characteristic are shown. FIG. 6A shows an exemplary embodiment where a lower nonlinear plant characteristic 304 and an upper nonlinear plant characteristic 306 can be combined to offset each other to form an ideal linear plant characteristic 302. A stable plant has a static characteristic curve, which is determined by the steady-state relation between the plant input and plant output. The slope of the curve is the plant static gain. When the relation between plant input and output is a straight line over the range of all inputs, the plant has a constant static gain. A system with variations in the slope means that the plant has static nonlinearity. In an exemplary embodiment, a system with static nonlinearity may have detrimental system performance characteristics, because coupling linear controllers with statically nonlinear plant means will create control performance characteristics that will vary with the operating point. For example, a loop might start oscillating at one point but be sluggish at another. In an exemplary embodiment, upper nonlinear plant characteristic 306 can be modified with lower nonlinearity plant characteristic 304 to obtain ideal linear plant characteristic 302.

In FIG. 6B, an exemplary embodiment is shown where upper nonlinear plant characteristic 306 has an inverted gain. This inversion occurs immediately proceeding upper nonlinear plant characteristic 306 passing through ideal linear characteristic point 308. In this exemplary embodiment, lower nonlinear plant characteristic 304 is a mirror image of upper nonlinear plant characteristic 306. Therefore, lower nonlinear plant characteristic 304 inverts immediately proceeding lower nonlinear plant characteristic 304 passing through ideal linear characteristic point 308.

In yet another embodiment, FIG. 6C shows that upper nonlinear plant characteristic 306 may transition from a gain to an inverted gain and back to a gain. In this exemplary embodiment, lower nonlinear plant characteristic 304 would be a mirror image of upper nonlinear plant characteristic 306. When upper nonlinear plant characteristic 306 is combined with lower nonlinear plant characteristic 304, the combination results in ideal linear plant characteristic 302.

FIG. 7 shows an exemplary closed loop system 340 that may be utilized with this disclosure. In an exemplary embodiment, closed loop system 340 is depicted in terms of discrete-time transfer functions showing a controller 354 and a plant 344. The extraneous signals entering the loop are the set point(rₜ) 350 and a disturbance signal(wₜ) 342. The latter signal is assumed to be a stochastic noise signal, such as an independently and identically distributed (iid) sequence that has a Gaussian distribution. In an exemplary embodiment, the loop is under regulatory control with the set point constant. The controller output(μₜ) 356, set point(rₜ) 350 and feedback signal(yₜ) 346 are all measurable.

An error signal 352 can be written in terms of the loop transfer functions as follows:

$${e}_{t} = - {w}_{t} \frac{B ( {q}^{- 1} ) R ( {q}^{- 1} ) {q}^{- d}}{A ( {q}^{- 1} ) R ( {q}^{- 1} ) + B ( {q}^{- 1} ) S ( {q}^{- 1} ) {q}^{- d}}$$

where q⁻ⁿ is a backward shift operator. This equation can be rewritten as the following autoregressive moving average (ARMA) process:

$${e}_{t} = {ɛ}_{t} \frac{D ( {q}^{- 1} )}{C ( {K}_{p} , {q}^{- 1} )}$$

where C and D are polynomials in the shift operator:

C(q⁻¹)=1+c₁q⁻¹+ . . . +cₙq⁻ⁿ; and D(q⁻¹)=1+d₁q⁻¹+ . . . +dₘq^{-m}

and ε is defined by:

εₜ=−wₜKₚK_{L}

the plant gain Kₚ has been factored out as a scalar coefficient and it also appears in the denominator of the ARMA process where the coefficients in C are functions of this gain, i.e., c₁, . . . , Cₙ=ƒ(Kₚ). An additional gain K_{L} is also factored out and this represents a constant that may be a function of the fixed controller and plant parameters.

In an exemplary embodiment, the closed loop system can be modeled as an ARMA process and the plant gain will appear in the denominator. In another exemplary embodiment, the closed loop system can be modeled as an ARMA process and the plant gain will appear in both the denominator and the numerator. In these exemplary embodiments, when all other loop attributes remain constant, the variance of a closed loop ARMA process will vary relatively linearly with plant gain within loosely defined regions of stability. It should be noted that the plant gain is not constant, but is expected to vary as a function of controller output 356. The variable plant gain thus causes nonlinearity in both the static and dynamic characteristics of the closed loop system.

In an exemplary embodiment, the control system's objective is to ascertain how the plant gain varies as a function of controller output 356. In this exemplary embodiment, the normalized function relating controller output 356 and plant output 346 (See FIGS. 1-5) is utilized to cancel the problem in a control loop. The normalized function ƒ(u) provides a mapping between intermediate values in the range of u to intermediate values in the range of y:

y=yₘᵢₙ+ƒ(u*)(yₘₐₓ-yₘᵢₙ)

where u*=(u-uₘᵢₙ)/(uₘₐₓ-uₘᵢₙ). As shown, the plant gain affects the gain of the loop transfer function and also its poles. Identification of the function ƒ(u) may be calculated utilizing these equations. In an exemplary embodiment, the system builds a picture of the nonlinear function ƒ(u) by linearizing the loop transfer function over small ranges of the control signal. In this exemplary embodiment, the ARMA model is fitted to the error signal when the controller input varies within a small range with a midpoint of uₘ. The fitted ARMA model can then be used to generate the residual sequence:

εₜ=(eₜ+ĉ₁eₜ₋₁+ . . . +ĉₙeₜ₋ₙ)−(\hat{d}₁εₜ₋₁+ . . . +\hat{d}ₙεₜ₋ₙ)

From equation εₜ=−wₜKₚK_{L} it can be deduced that the variance of the residual sequence at uₘ is given by:

σ²(ε)=Kₚ²(uₘ)[K_{L}²σ²(w)]

In this exemplary embodiment, the plant gain is the only term contributing to the variance that is not a constant. Hence, the variance of the ARMA residuals will be a linear function of the square of the plant gain. In an exemplary embodiment, this result can be exploited to estimate the function ƒ(u) by obtaining multiple ARMA models at different sub-ranges of the controller output spanning its total range.

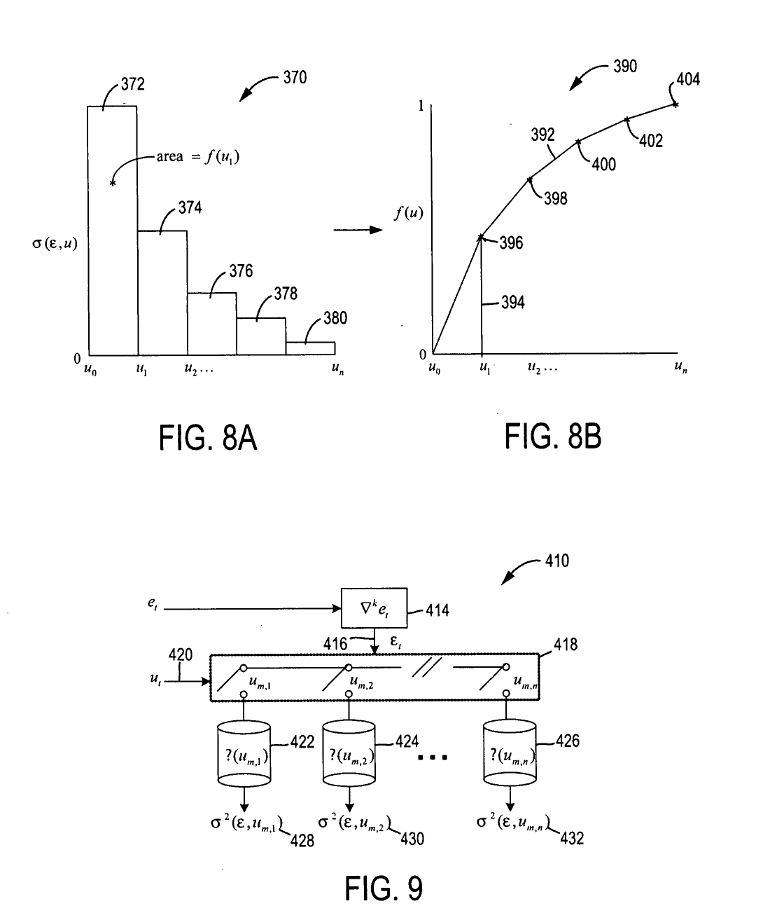

In FIGS. 8A-8B, an exemplary embodiment procedure is described. First, divide the control signal (normalized between zero and one) into sub-ranges where the demarcation points are {u₀,u₁, . . . ,uₙ}. Next obtain n ARMA models corresponding to the sub-ranges of u and use the models to generate n residual sequences and corresponding variances (or standard deviations) {σ₁,σ₂, . . . ,σₙ}. The standard deviations are equivalent to the plant gains multiplied by a constant and these estimates can be integrated over their corresponding ranges of u in order to construct a piecewise linearization of the function ƒ(u). Estimates of the function ƒ(u) and the end points of the u sub-ranges is thus given by:

$$f ( {u}_{j} ) = \frac{{\sum }_{i = 0}^{j} {σ}_{i} ( {u}_{i + 1} - {u}_{i} )}{{\sum }_{i = 0}^{n} {σ}_{i} ( {u}_{i + 1} - {u}_{i} )} , j ∈ \{ 1 , … , n \}$$

where: ƒ(0)=0. The process of transforming the standard deviation estimates into the nonlinearity curve is illustrated graphically in FIGS. 8A-8B. In this exemplary embodiment, graph 370 illustrates the areas of the function ƒ(u) as a first area 372, a second area 374, a third area 376, a fourth area 378, and a n^{th} area 380.

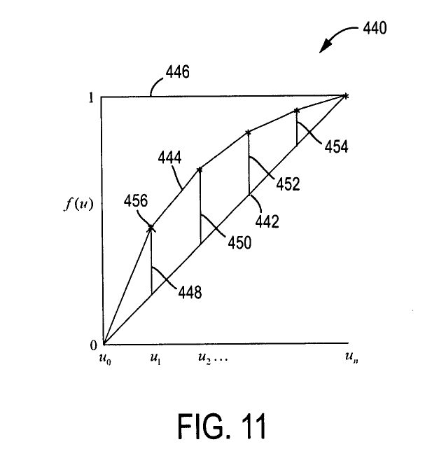

In FIG. 8B, the function ƒ(u) is compared to u in graph 390. In an exemplary embodiment, plants in the system may be ranked according to their performance characteristics. First plant may have first plant performance characteristic 396, second plant may have second plant performance characteristic 398, third plant may have third plant performance characteristic 400, fourth plant may have fourth plant performance characteristic 402 and n^{th} plant may have n^{th} plant performance characteristic 404. The plants' performance characteristics may be graphed to form plants' performance characteristics line 392. A plant ƒ(u) measurement 394 represents the plant's performance and may be compared to an ideal performance line 442 (see FIG. 11) to prioritize plants on a plant priority list.

The exemplary procedure described above involves fitting multiple ARMA models to data divided into sub-ranges of the controller output signal. In this exemplary embodiment, the ARMA model was used to de-correlate the error signal data and neutralize the effects of the nonlinear plant gain on the closed loop poles. In another exemplary embodiment, identification of the zeros may not be needed because they are not functions of the gain and would remain constant. Having an additional constant in the numerator of equation

$${e}_{t} = {ɛ}_{t} \frac{D ( {q}^{- 1} )}{C ( {K}_{p} , {q}^{- 1} )}$$

would not affect the estimation of ƒ(u) because only relative gains are used to construct the function.

In FIG. 9, an alternative exemplary embodiment to fitting the ARMA models to the error signal is to use differencing to provide the de-correlation is shown. A first-order differencing can be effective in a single pole dominated loop. In an exemplary embodiment, higher-order differencing may be utilized when other poles are significant. In this exemplary embodiment, the differencing approach may be more robust than fitting ARMA models because the ARMA parameter estimates will be sensitive to corruption in the autocorrelation that would occur as the error signal transgresses demarcation points. The differencing approach is intrinsically non-parametric and would therefore not be prone to these kinds of estimation problems. In an exemplary embodiment, the approach is implemented by constructing a new innovation sequence (ε) 416 to replace the one generated by the estimated ARMA model in equation

εₜ=(εₜ+ĉ₁eₜ₋₁+ . . . +ĉₙeₜ₋ₙ)−(\hat{d}₁εₜ₋₁+ . . . +\hat{d}ₙεₜ₋ₙ). i.e.,

εₜ=▾^{k}eₜ

where ▾ is a difference operator 414 defined by: ▾^{k}eₜ=(1−q⁻¹)^{k}eₜ; with k being the level of differencing performed on the signal. A variance 428, 430, 432 of new innovation sequence(ε) 416 sequence at difference sub-regions of the control signal is then given by:

σ²(ε)=Kₚ²(uₘ)[C+δ(uₘ)]

where uₘ denotes the center value of the sub-region and C is a constant. The term δ(uₘ) represents an additional component that remains in the expression as some unknown function of controller output 356. The additional component exists because the differencing will not completely de-correlate the data. In an exemplary embodiment, the value will be very small relative to C and can thus be ignored. The function ƒ(u) can then be estimated, as before using the equation

$$f ( {u}_{j} ) = \frac{{\sum }_{i = 0}^{j} {σ}_{i} ( {u}_{i + 1} - {u}_{i} )}{{\sum }_{i = 0}^{n} {σ}_{i} ( {u}_{i + 1} - {u}_{i} )} , j ∈ \{ 1 , … , n \} ,$$

by utilizing variances estimated from the differenced sequences corresponding to sub-regions of u.

In this exemplary embodiment, implementation of the method is completed as follows. The sub-regions of controller output 356 are determined. The system utilizes a performance logic 418 to separate differenced error signal values 420 into separate batches 422, 424, 426 based on the value of controller output 356 over which the differencing is performed. After enough samples have been accumulated in the sub-batches, the system estimates the respective variances and the plant gain function. The procedure is illustrated graphically in FIG. 9, where uₘ denotes the midpoints of the selected sub-ranges of u.

In an exemplary embodiment, further adaptation of the system may entail introducing recursive updating of the variance estimates so that entire batches of data do not need to be stored. In this exemplary embodiment, the system assumes that the error signal is stationary, the differenced sequence will have an expected value of zero. In this case, the variance is equivalent to the mean square and a recursive formula for this is:

$${σ}_{i}^{2} = {σ}_{i - 1}^{2} + \frac{{ɛ}_{i}^{2} - {σ}_{i - 1}^{2}}{i}$$

Equation

$${σ}_{i}^{2} = {σ}_{i - 1}^{2} + \frac{{ɛ}_{i}^{2} - {σ}_{i - 1}^{2}}{i}$$

enables estimates of the variance to be updated as each new sample is obtained rather than having to re-process a batch of samples. As i→∞, the sensitivity of the variance estimates clearly diminishes for new samples of ε. In an exemplary embodiment, it may be useful to adopt a time-weighted approach so that the variance estimates remain sensitive to new data. This exemplary embodiment may be achieved by modifying equation

$${σ}_{i}^{2} = {σ}_{i - 1}^{2} + \frac{{ɛ}_{i}^{2} - {σ}_{i - 1}^{2}}{i}$$

so that the updated equation becomes an exponentially weighted moving average (EWMA):

$${σ}_{i}^{2} = {σ}_{i - 1}^{2} + \frac{{ɛ}_{i}^{2} - {σ}_{i - 1}^{2}}{min ( i , W )}$$

where the weight assigned to each new value diminishes with time such that the weight at W samples old is exp(−1). The W value would be set according to expectations about the time-varying nature of the control loop being monitored.

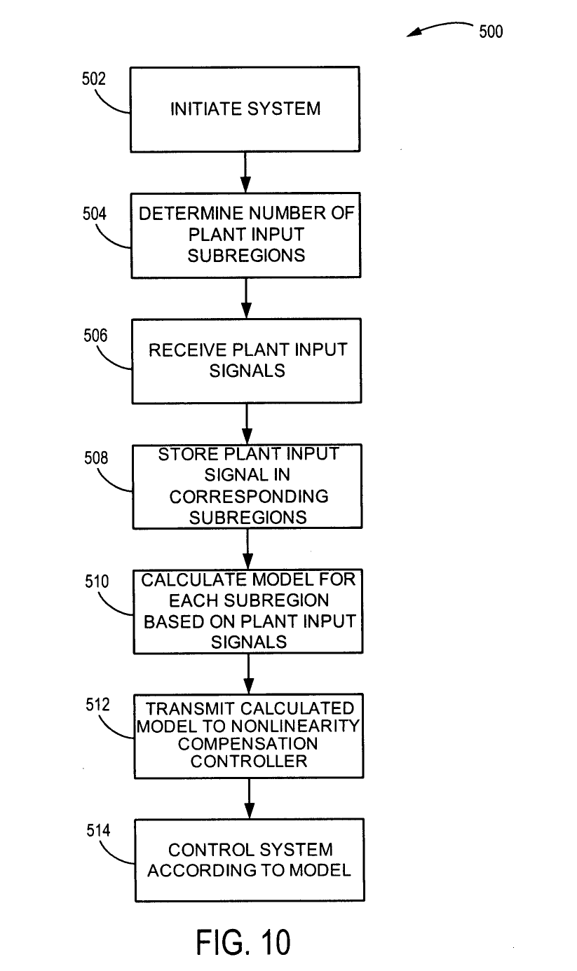

In FIG. 10, a system process flow 500 is shown. In step 502, the system is initiated. In an exemplary embodiment, the system may be initiated automatically based on predetermined time intervals or system performance characteristics, via input devices, via audio commands or any combination thereof. In step 504, the system determines the number of plant input sub-regions. In step 506, the system receives plant input signals. In step 508, the system stores the plant input signal in corresponding sub-regions. In step 510, the system calculates a model of each sub-region based on the plant input signals. In step 512, the system transmits the calculated model to nonlinearity compensation controller 236. In step 514, nonlinearity compensation control 236 compensates for nonlinearity in flow controller 210 by modifying flow control signal 240 and transmitting a modified flow control signal 241 to actuator 72.

In FIG. 11, an actuators' performance graph 440 is shown. Actuators' performance graph 440 includes ideal performance line 442, a worst case performance line 446 and an actual performance line 444. Actuators 72 can be prioritized based on first actuator performance line 448, second actuator performance line 450, third actuator performance line 452 and n^{th} actuator performance line 454. Actuators' 72 performance characteristics may be determined to prioritize resource allocation. In an exemplary embodiment, actuators' 72 performance characteristics may be display in table format as follows:

| Actuator | Performance Index |
|---|---|
| 1 | 1.0 |
| 2 | 0.9 |
| 3 | 0.8 |
| 4 | 0.75 |
| 5 | 0.66 |
| 6 | 0.52 |
| 7 | 0.21 |
| 8 | 0.02 |

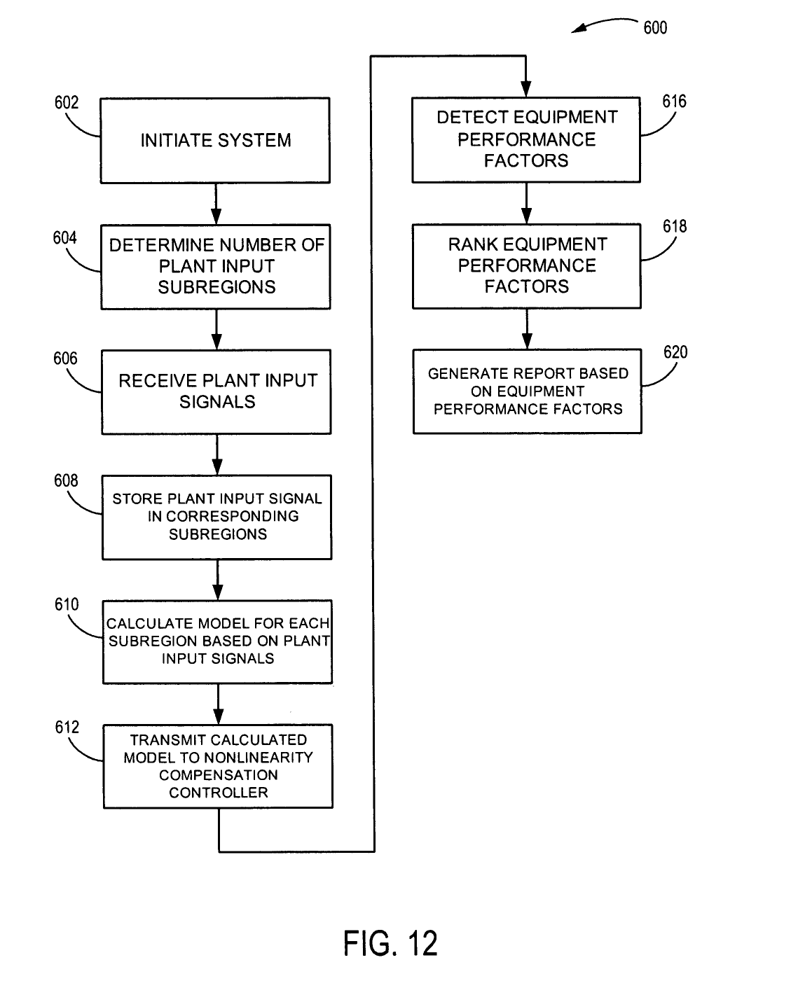

In FIG. 12, a process flow 600 for actuators' 72 performance ranking is shown. The system is initiated (step 602). In an exemplary embodiment, the system may be initiated automatically based on predetermined time intervals or system performance characteristics, via input devices, via audio commands or any combination thereof. The system determines the number of plant input sub-regions (step 604). The system receives plant input signals (step 606). The system stores the plant input signal in corresponding sub-regions (step 608). The system calculates a model of each sub-region based on the plant input signals (step 610). The system transmits the calculated model to nonlinearity compensation controller 236 (step 612). The actuator 72 performance factors are determined (step 616). A prioritization logic prioritizes actuator 72 performance factors (step 618). A report logic generates a report based on actuator 72 performance factors (step 620).

The exemplary embodiments illustrated in the figures and described herein are offered by way of example only. Accordingly, the present application is not limited to a particular embodiment, but extends to various modifications that nevertheless fall within the scope of the appended claims. The order or sequence of any processes or method step may be varied or re-sequenced according to alternative embodiments.

The present application contemplates methods, systems and program products on any machine-readable media for accomplishing its operations. The embodiments of the present application may be implemented using an existing computer processor, or by a special purpose computer processor for an appropriate system, incorporated for this or another purpose or by a hardwired system.

It is important to note that the construction and arrangement of the control system as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

As noted above, embodiments within the scope of the present application include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machine to perform a certain function or group of functions.

It should be noted that although the figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule based logic and other logic to accomplish the various connection steps, processing steps, comparison steps and decision steps.

What is claimed is:

1. An environment control system comprising:
a network;
a plurality of units, the plurality of units including at least one control unit for controlling a portion of a process;
a controller, the controller operatively associated with the at least one control unit and comprising:
a control unit output in communication with the at least one control unit, wherein the control unit output is configured to provide a control signal for controlling the at least one control unit;
a communication port;
a memory; and
a processor in communication with the memory, the control unit output, and the communication port;
wherein the processor is configured to provide the control signal to control the at least one control unit, the processor programmed to perform a calculation logic and store a calculation logic result in the memory.

2. The environment control system of claim 1, wherein a plant input is utilized by the calculation logic to calculate a nonlinearity compensation correction signal.

3. The environment control system of claim 2, wherein the nonlinearity compensation correction signal is transmitted to a nonlinearity compensation controller; and
wherein the nonlinearity compensation controller receives the control signal and modifies the control signal based on the nonlinearity compensation correction signal and transmits a modified control signal to the at least one control unit.

4. The environment control system of claim 1, wherein the calculation logic determines a number of plant input sub-regions, receives plant input signals, stores plant input signals into plant input sub-regions categories, calculates a model for the sub-regions based on the plant input signals, and transmits the model to a nonlinearity compensation controller.

5. The environment control system of claim 4, wherein a nonlinearity compensation correction signal is transmitted to the nonlinearity compensation controller; and
wherein the nonlinearity compensation controller receives the control signal and modifies the control signal based on the nonlinearity compensation correction signal and transmits a modified control signal to the at least one control unit.

6. The environment control system of claim 5, wherein the nonlinearity compensation correction signal is based on a time series model result.

7. The environment control system of claim 6, wherein the time series model result is derived utilizing an autoregressive moving average.

8. In a control network including a plurality of individual controllers, the controllers being in communication with a communication link, the communication link being in communication with a computing device, the controllers cooperating to control a process, a method of generating a performance index for monitoring performance of the controllers, the method comprising the steps of:
periodically sampling a parameter related to the process for each of the plurality of controllers, wherein the parameter is received from a sensor;
generating a time series model of the parameter, the time series model of the parameter being the performance index;
storing the time series model of the parameter; and
transmitting the stored time series model of the parameter to the computing device in response to a command from the computing device.

9. The method for generating a performance index of claim 8, wherein a plant input is utilized by the calculation logic to calculate a nonlinearity compensation correction signal.

10. The method for generating a performance index of claim 9, wherein the nonlinearity compensation correction signal is transmitted to a nonlinearity compensation controller; and
wherein the nonlinearity compensation controller receives the control signal and modifies the control signal based on the nonlinearity compensation correction signal and transmits a modified control signal to the at least one control unit.

11. The method for generating a performance index of claim 8, wherein the calculation logic determines a number of plant input sub-regions, receives plant input signals, stores plant input signals into plant input sub-regions categories, calculates a model for the sub-regions based on the plant input signals, and transmits the model to a nonlinearity compensation controller.

12. The method for generating a performance index of claim 11, wherein a nonlinearity compensation correction signal is transmitted to the nonlinearity compensation controller; and
wherein the nonlinearity compensation controller receives the control signal and modifies the control signal based on the nonlinearity compensation correction signal and transmits a modified control signal to the at least one control unit.

13. The method for generating a performance index of claim 12, wherein the nonlinearity compensation correction signal is based on a time series model result.

14. The method for generating a performance index of claim 13, wherein the time series model result is derived utilizing an autoregressive moving average.

15. An environmental controller operatively associated with an environmental device, the environmental controller in communication with a communications bus, the environmental controller for use in a system including a station in communication with the communication bus, the environmental controller comprising:
parameter input means for receiving a parameter value from a sensor;
a communication port in communication with the communication bus;
a memory for storing system data including diagnostic information; and
a processor in communications with the memory, the parameter input means, and the communication port;
wherein the processor is configured to generate diagnostic information and receive the parameter value;
wherein the process is configured to include a means for generating the diagnostic information and a means for deriving the diagnostic information from a calculation logic; and
wherein the processor is configured to provide the diagnostic information to the communication port, the communication port is configured to provide the diagnostic information to the communication bus and the communication bus is configured to provide the diagnostic information to the station.

16. The environmental controller operatively associated with an environmental device of claim 16, wherein a plant input is utilized by the calculation logic to calculate a nonlinearity compensation correction signal.

17. The environmental controller operatively associated with an environmental appliance of claim 15, wherein the nonlinearity compensation correction signal is transmitted to a nonlinearity compensation controller; and
wherein the nonlinearity compensation controller receives the control signal and modifies the control signal based on the nonlinearity compensation correction signal and transmits a modified control signal to the at least one control unit.

18. The environmental controller operatively associated with an environmental appliance of claim 15, wherein the calculation logic determines a number of plant input sub-regions, receives plant input signals, stores plant input signals into plant input sub-regions categories, calculates a model for the sub-regions based on the plant input signals, and transmits the model to a nonlinearity compensation controller.

19. The environmental controller operatively associated with an environmental appliance of claim 18, wherein a nonlinearity compensation correction signal is transmitted to the nonlinearity compensation controller; and
wherein the nonlinearity compensation controller receives the control signal and modifies the control signal based on the nonlinearity compensation correction signal and transmits a modified control signal to the at least one control unit.

20. The environmental controller operatively associated with an environmental appliance of claim 19, wherein the nonlinearity compensation correction signal is based on a time series model result.
